(19) United States
(12) Patent Application Publication
(10) Pub. No.: US 2011/0157063 A1
(43) Pub. Date: Jun. 30, 2011

(54) INFORMATION PRECESSING DEVICE AND RELATED METHOD

(76) Inventors: Sadao YAMAMOTO, Saitama (JP); Masahiko ABE, Saitama-ken (JP)

(21) Appl. No.: 13/043,938

(22) Filed: Mar. 9, 2011

Related U.S. Application Data
(63) Continuation of application No. 11/699,508, filed on Jan. 30, 2007.

(30) Foreign Application Priority Data
Jan. 31, 2006 (JP) 2006-022999

(51) Int. Cl. G06F 3/041

(52) U.S. Cl. 345/173

(57) ABSTRACT

A portable information processing system is provided which includes a display unit having an electronic display and a display unit interface, an electronic tablet mountable on the display unit, and a hand-holdable, hand-guidable electronic position indicator for transmitting the signals for receipt by the electronic tablet. The electronic tablet includes a transparent window positioned in overlaying arrangement on the electronic display when the electronic tablet is mounted on the display unit to permit viewing of the electronic display through the transparent window, an input processing system adapted to receive signals and process character information and coordinate information based on the signals, and an electronic tablet interface for communicating with the display unit interface of the display unit.

### CROSS-REFERENCES TO RELATED APPLICATIONS

The present application claims priority from Japanese Application No. P2006-022999, filed on Jan. 31, 2006, the disclosure of which is incorporated herein by reference.

### FIELD OF THE INVENTION

The present invention relates to an information processing device, and in particular relates to an information processing device having a plurality of electronic display sheets, such as electronic papers. The present invention also relates to methods for making and operating the information processing device.

### BACKGROUND OF THE INVENTION

In recent years there have been vigorous efforts to develop new electronic display media, such as electronic paper, flexible displays, and other sheet-type display devices (also referred to herein as electronic display sheets), which incorporate the advantages of paper as a display media. These advantages include excellent visibility, ease of viewing without fatigue, foldability, and otherwise excellent portability.

However, in the present state of the art, development of independent electronic paper and flexible display devices is being conducted with emphasis essentially placed on strictly display devices, such as electronic books, electronic newspapers, flexible television, and other display applications. Not been much development progress has been made with respect to devices in which users can write freely, such as electronic notebooks.

### SUMMARY OF THE INVENTION

Hence an object of the invention is to provide an information processing device which, like an electronic notebook, has electronic display sheets into which users can write, and which can easily be used to reference information which users have affixed or written.

In order to attain this object, a first aspect of the invention provides an information processing device comprising a plurality of electronic display sheets bound in notebook form, and a position information input portion. Each of the electronic display sheets has a display face. The position information input portion is movable relative to the electronic display sheets into opposing relationship with respect to the display face of any of the electronic display sheets of the plurality of electronic display devices sheets selected by a user. The position information input portion comprises an input face for permitting the user to input information at a position on the input face for display at a corresponding position on the display face of the selected electronic display sheet.

According to a second aspect of the invention, the above-described information processing device of the first aspect is provided, and the input face of the position information input portion is positioned to oppose, either directly or indirectly, the display face of any electronic display sheet selected by the user among the plurality of the electronic display sheets. The user inputs information at a position on the input face of the position information input portion for display at a corresponding position on the electronic display sheet.

According to an implementation of the above first and second aspects of the invention, the position information input portion detects the position at which the user inputs the information on the input face, and associates the position on the input face with a corresponding display position on the display face of the selected electronic display sheet.

According to another implementation of the above first and second aspects of the invention, the information processing device may further comprise a display control portion which displays the input information on the display face at the corresponding position on the displace face of the selected electronic display sheet. The display control portion may display, for example, an image, based on the input information, on the display face of the electronic display sheet.

According to implementations of this invention, the electronic display sheets may be configured as electronic paper or flexible displays. The display face may be present on the front-face side or the rear-face side, or display faces may be placed on both the front-face side and the rear-face side, respectively.

As used herein, the phrase “opposing relationship” encompasses placing the position information input portion directly on indirectly on the same side or the reverse (facing away) side of the selected electronic display sheet relative to the display face. The position information input portion may be configured, for example with a transparent window, to enable viewing of the display face of the selected electronic display sheet when the position information input portion is placed over (on the same side as) the display face. Further, the position information input portion may be configured as a pressure-sensitive or an electromagnetic-induction tablet.

The information processing device may further comprise a position indicator, such as a pen-type device. The position indicator may comprise at least one coil enabling the user to specify a position, and the position information input portion may comprise a plurality of loop coils. Signals may be transmitted from the position indicator coil to a selected one of the loop coils, and/or from the loop coils to the position indicator coil, to identify a position specified by the user with the position indicator.

Moreover, the position indicator may comprise at least one coil enabling the user to specify a position, and the position information input portion may be configured as an electromagnetic induction tablet, including a plurality of loop coils to receive signals transmitted from the coil of the position indicator.

According to another implementation of the first and second aspects of the invention, the information processing device further comprises a selection state specification portion, which determines which of the electronic display sheets is selected by the user from among the plurality of electronic display sheets. The selection state specification portion may further determine selection between the front and rear side display faces.

The selection state specification portion may read unique identification codes of identification portions of the electronic display sheets, and determine which of the electronic display sheets is selected by the user based on the identification codes. Alternatively, the selection state specification portion may determine the shape of an identification portion, which is unique for each of the electronic display sheets, and determine which of the electronic display sheets is selected by the user based on the shape of the identification portion. The unique shapes may comprise holes formed into specific shapes, and the selection state specification portion may irradiate the position in which the hole is formed with light, and use the transmission position to specify the electronic display sheet selected by the user.

According to another implementation of the first and second aspects of the invention, the position information input portion may be formed integrally with a control unit.

According to another implementation, first and second position information input portions may be provided for inputting position information corresponding to a position specified by the user. The first position information input portion and second position information input portion may be placed in opposing relationship with respect to the display faces of any one of the electronic display sheets selected by the user. The selection state specification portion may which of the display faces of the electronic display sheet is selected by the user, based on position information input from either the first position information input portion or from the second position information input portion. This implementation is especially useful for electronic display sheets comprising front and rear display faces.

According to a further implementation, the each electronic display sheet may comprise a front display face on the front side of the electronic display sheet and a rear display face on the rear side of the electronic display sheet. The position information input portion may be movable into facing relationship with respect to the front and rear display faces. The information processing device of this implementation further includes a selection state specification portion for detecting which of the front and rear display faces is selected by the user.

Advantageously, the information processing device of the above aspects can be used in the manner of a notebook, so that a user can write information, and can easily reference information that has been input, e.g., written.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a perspective view of a notebook information processing device of an embodiment of the invention;

FIG. 2 is a block diagram depicting an operations overview for the notebook information processing device of FIG. 1;

FIG. 3 is a diagram depicting an operations overview of a tablet of the notebook information processing device of FIG. 1;

FIG. 4 is a cross-sectional view of electronic paper suitable for the notebook information processing device of FIG. 1;

FIG. 5 is a conceptual diagram of an electrode portion and display driver of an electrophoretic display panel of the electronic paper of FIG. 4;

FIG. 6 is a plan view of the notebook information processing device of FIG. 1 in use;

FIG. 7 is a perspective view of a notebook information processing device of a second embodiment of the invention;

FIG. 8 is a perspective view of a notebook information processing device of a third embodiment of the invention, depicting the deployment of an integral tablet;

FIG. 9 is a perspective view of a notebook information processing device of a fourth embodiment of the invention;

FIG. 10 is a perspective view of a notebook information processing device of a fifth embodiment of the invention, depicting the deployment of a first of a plurality of integral tablets;

FIG. 11 is an overhead view of a notebook information processing device of a sixth embodiment of the invention; and

FIG. 12 is an overhead view of a notebook information processing device of a seventh embodiment of the invention.

### DETAILED DESCRIPTION OF THE PREFERRED EMBODIMENTS AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

### [1] First Embodiment

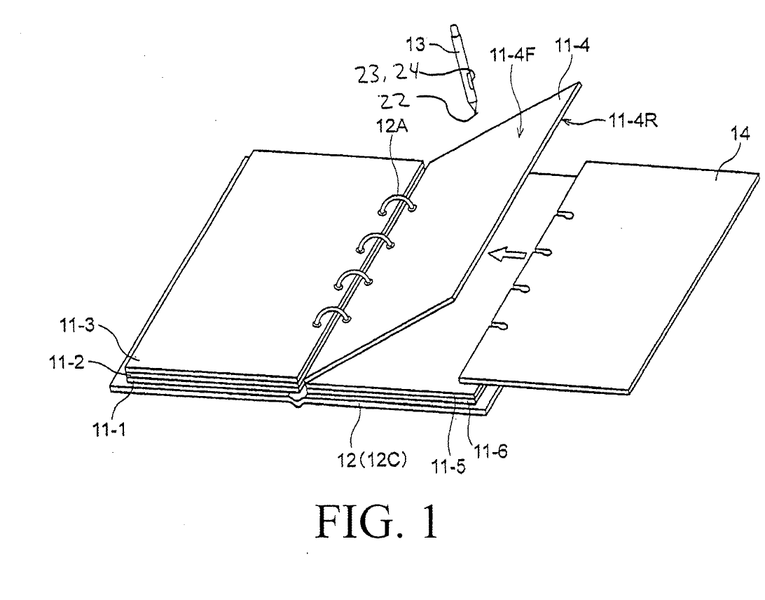

The notebook-type information processing device 10 comprises a plurality of electronic paper sheets (sheet-type display devices) 11-1 to 11-6. It should be understood that the device 10 may include more or fewer electronic paper sheets than illustrated. The device 10 further includes a display unit 12, which functions as a display control portion. The display unit 12 is configured as a binder in the illustrated embodiment. The binder has opposite front and rear panels (or covers), and a spine integrally connecting the front and back panels to allow opening and closing of the notebook. The display unit 12 further includes ring-type holders 12A for holding the electronic paper sheets 11-1 to 11-6 within the binder and performing electrical connection operations. Four ring-type holders 12A are shown in FIG. 1, although it should be understood that the display unit 12 may contain fewer or more holders 12a. The electronic papers sheets 11-1 to 11-6 are retained by holders 12a in such a manner that the front faces of the sheets 11-1 to 11-6 are face up on the right side (back panel) and face down on the left side (front panel) of the display device 12, based on the orientation of the device 10 shown in FIG. 1. For example, in FIG. 1, reference numeral 11-4F designates the front surface of the electronic paper sheet 11-4 and reference numeral 11-4R designates the rear surface of the electronic paper sheet 11-4.

An underlay-type tablet (also referred to herein as a position information input portion) 14 of the device 10 is movable relative to the electronic display sheets 11-1 to 11-6. As referred to herein, relative movement encompasses either movement of the tablet 14 or movement of the electronic display sheets 11-1 to 11-6 relative to the other, or movement of both. The tablet 14 is removably joined to the ring-type holders 12A in the illustrated first embodiment. The tablet 14 may be removed from the ring-type holders 12A and inserted between any of the electronic paper sheets 11-1 to 11-6. For example, in FIG. 1 the tablet 14 is inserted between the rear face 11-4R of electronic paper sheet 11-4 and the front face of electronic paper sheet 11-5. The tablet 14 allows input of position information corresponding to positions specified by the user using a pen-type position indicator 13 in association with display coordinates on an electronic paper sheet 11-1 to 11-6, and with particular reference to FIG. 1 on the front surface side 11-4F of the electronic paper sheet 11-4. The tablet 14 of this embodiment is referred to as an underlay-type tablet, because the tablet 14 is under electronic paper sheet 11-4 during operation.

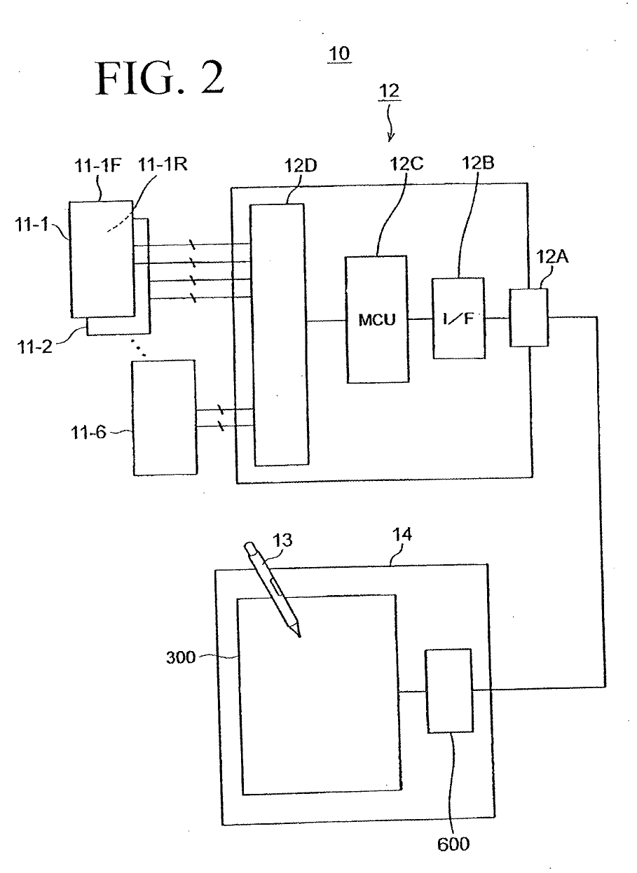

As best shown in FIG. 2, the display unit 12 comprises an interface portion 12B, which performs interface operations with external equipment via electrical connections established by the ring-type holders 12A; a microcomputer unit (MCU) 12C, which controls the entirety of the display unit 12; and a display driver 12D, which drives the electronic paper sheets 11-1 to 11-6 under control of the MCU 12C.

The underlay-type tablet 14 is configured so as to enable the user to perform position specification using the pen-type position indicator 13. As best shown in FIG. 2, the tablet 14 comprises a position detection portion 300 which generates position detection signals in concert with the pen-type position indicator 13. The tablet 14 further comprises a tablet control portion 600, which generates and outputs position coordinate data based on the position detection signals generated by the position detection portion 300, and generates and outputs operation data (e.g., stylus pressure data, switch operation data) for the pen-type position indicator 13.

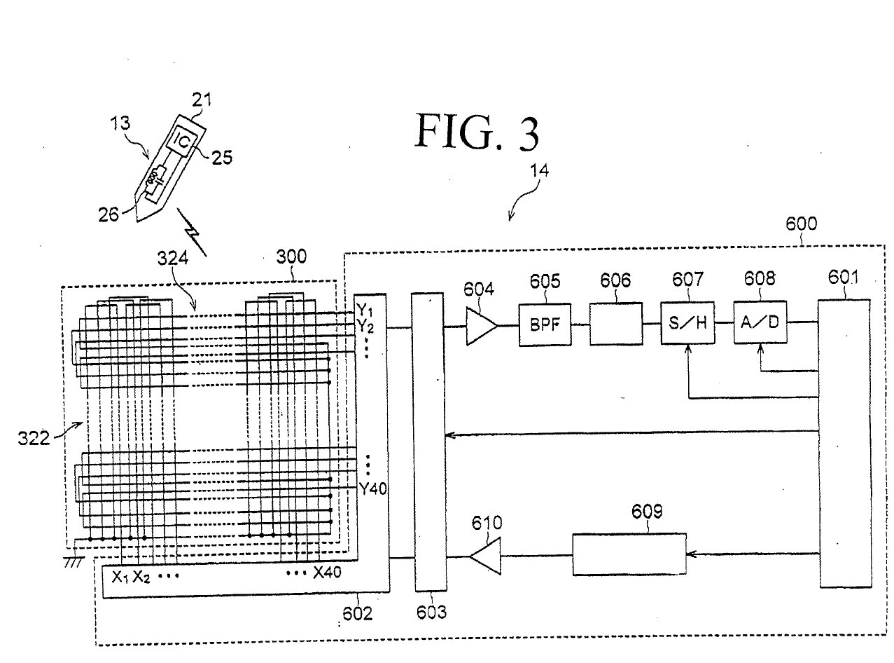

The underlay-type tablet 14 will now be explained in detail with reference to FIG. 3.

As shown in FIG. 3, the position detection portion 300 has a plurality of loop coils 322 and loop coils 324 each connected to and preferably housed in the underlay-type tablet 14. Loop coils 322 are arranged perpendicular to loop coils 324 to establish an X-Y grid.

The pen-type position indicator 13 comprises a resonance circuit 26 containing a coil and capacitor. The resonance circuit 26 is connected to the IC 25.

The tablet control portion 600 of the underlay-type tablet 14 comprises a selection circuit 602, which selects one loop coil from among the plurality of loop coils 322, 324 of the position detection portion 300. The tablet control portion 600 further comprises a transmit/receive switching circuit 603, which switches between a transmission mode in which signals are transmitted to a loop coil of loop coils 322, 324 selected by the selection circuit 602, and a reception mode in which signals are received from the pen-type position indicator 13 by the loop coil of loop coils 322, 324 selected by the selection circuit 602.

Also, the tablet control portion 600 comprises a control circuit 601, which controls each of the portions of the underlay-type tablet 14; an amplification circuit 604, which amplifies the signal output from the transmit/receive switching circuit 603; a BPF (band-pass filter) 605, which passes only the signal component in a prescribed frequency band of the signal amplified by the amplification circuit 604; a detection circuit 606, which converts the signal component passed by the BPF 605 into a voltage value; a sample/hold circuit 607, which holds the voltage value for a prescribed time; an A/D conversion circuit 608, which converts the voltage value held by the sample/hold circuit 607 into digital data and outputs the data to the control circuit 601; a signal generation circuit 609, which generates an oscillation signal of prescribed frequency under the control of the control circuit 601; and an amplification circuit 610, which amplifies the signal generated by the signal generation circuit 609, and outputs the result to the transmit/receive switching circuit 603.

The tablet control portion 600 of the underlay-type tablet 14 uses the following procedure to detect a position input operation performed by the pen-type position indicator 13.

First, the control circuit 601 controls the selection circuit 602 to cause selection of one loop coil from loop coils 322, 324, and controls the transmit/receive switching circuit 603 to switch the operating mode to the transmission mode.

Subsequently, the control circuit 601 of the tablet control portion 600 controls the signal generation circuit 609 to cause generation of a signal of prescribed frequency. This signal is amplified by the amplification circuit 610 and input to the selection circuit 602 via the transmit/receive switching circuit 603, so that current flows in the loop coil of loop coils 322, 324 selected by the selection circuit 602 according to this signal. In this manner, a magnetic field is generated in the vicinity of the selected loop coil of loop coils 322, 324.

In the pen-type position indicator 13, an induced current flows in the resonance circuit 26 due to the magnetic field generated in the vicinity of the loop coils 322, 324 of the position detection portion 300, so that the IC 25 begins operation. The IC 25 generates a signal of prescribed frequency for the resonance circuit 26, and this signal is transmitted from the resonance circuit 26 to the underlay-type tablet 14.

The control circuit 601 of the underlay-type tablet continues operation in the above-described transmission mode for a prescribed length of time, and then controls the transmit/receive switching circuit 603 to switch the operating mode to the reception mode. By switching modes, a signal from the signal generation circuit 609 is no longer output to the selection circuit 602.

In the reception mode, the signal transmitted from the pen-type position indicator 13 by operation of the IC 25 is received by the loop coil selected by the selection circuit 602. More specifically, the operation of the IC 25 causes a signal to be applied to the resonance circuit 26, so that a current flows in the resonance circuit 26 according to this signal, and a magnetic field appears in the vicinity of the resonance circuit 26. As a result of this magnetic field, an induced current flows in the loop coils 322, 324. Then, after the induced current flowing in the selected loop coil is amplified by the amplification circuit 604, only the component in a prescribed frequency band is output by the BPF 605 to the detection circuit 606. This signal component is converted into a voltage value by the detection circuit 606, and is held by the sample/hold circuit 607. The voltage value held by the sample/hold circuit 607 is converted into digital data by the A/D conversion circuit 608 at each prescribed time interval, and the data is output to the control circuit 601.

Then, the control circuit 601 uses the selection circuit 602 to select in succession the loop coils 322, 324. By performing computation processing of the digital data input from the A/D conversion circuit 608, the control circuit 601 identifies the loop coil closest to the position indicated by the pen-type position indicator 13, and determines the coordinates of the indicated position.

Also, while the induced current is flowing in the resonance circuit 26, the IC 25 of the pen-type position indicator 13 detects the stylus pressure applied to the core 22 (FIG. 1) and the operating states of the switches 23 and 24 (FIG. 1) accessible on the outer housing of the position indicator 13. The IC 25 changes the transmission timing and transmission time of the oscillation signal for the resonance circuit 26 (FIG. 3) according to the stylus pressure and operating states. The change in the transmission timing and transmission time is reflected when converting the voltage value held by the sample/hold circuit 607 into digital data using the A/D conversion circuit 608. The control circuit 601 of the underlay-type tablet 14 then performs computation processing of the digital data input from the A/D conversion circuit 608, to acquire the stylus pressure and the operating states of the switches 23 and 24.

Thereafter, the control circuit 601 outputs to the display unit 12 position-coordinate data corresponding to the position specified by the pen-type position indicator 13, and operating data indicating the stylus pressure of the pen-type position indicator 13 and the operating states of the switches 23 and 24.

Next, the configuration of electronic paper sheets 11-1 to 11-6 will be explained.

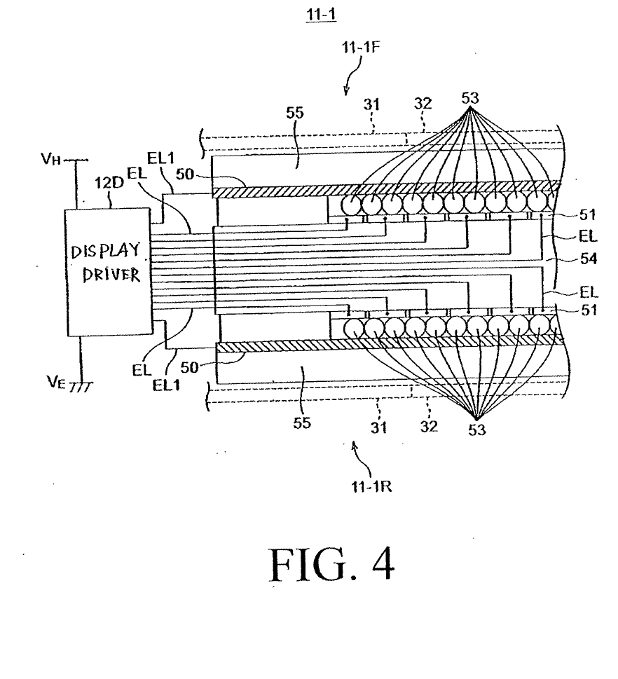

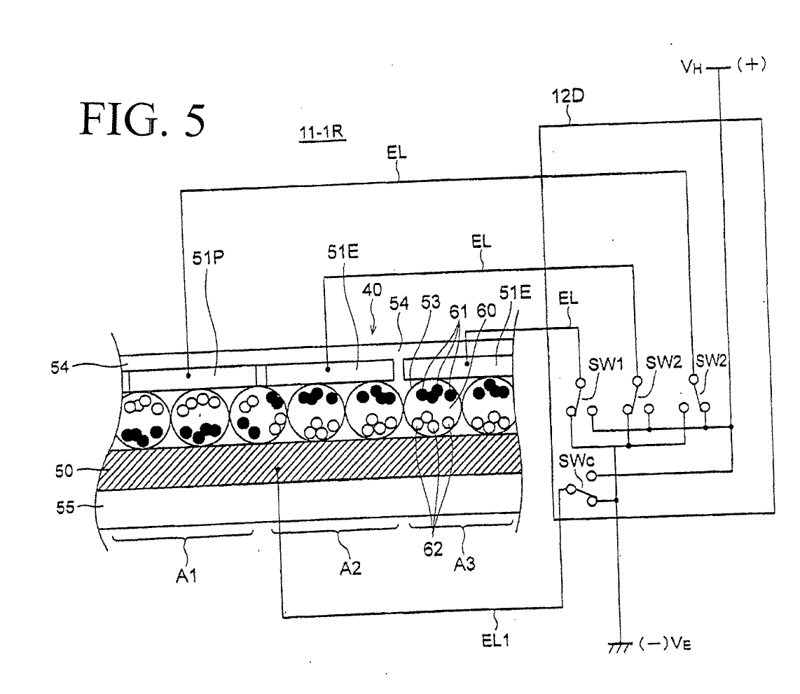

In FIG. 4, a case (or housing) 31 and a cover 32 of the electronic paper sheet 11-1 are indicated by phantom (dashed) lines together with the electrophoretic display panel. In FIG. 4 and FIG. 5, electrode wiring is omitted except for the minimum amount necessary for the explanation.

The electronic paper sheets 11-1 to 11-6 each comprise two electrophoretic display panels (display faces), on the front and rear faces, respectively. Because each of the electronic paper sheets 11-1 to 11-6 have the same configuration, in the following explanation only the electrophoretic display panel 11-1F and the electrophoretic display panel 11-1R of the electronic paper sheet 11-1 are explained in detail. It should be understood that that same features and functions apply to the display panels of electronic paper sheets 11-2 to 11-6. It should be further understood that one or more or all of the electronic paper sheets 11-1 to 11-6 may comprise a single electrophoretic display panels.

As shown in FIG. 4, the electrophoretic display panels 11-1F, 11-1R each have a respective pair of a transparent electrode 50 and dot electrodes 51. The electrode pair of the display panel 11-1F is situated above the electrode pair of the display panel 11-1R in the orientation shown in FIG. 4. A first plurality of microcapsules 53 establishing a first electrophoretic layer is enclosed between the transparent electrode 50 and the dot electrodes 51 of the electrophoretic display panel 11-1F. A second plurality of microcapsules 53 establishing a second electrophoretic layer is enclosed between the transparent electrode 50 and the dot electrodes 51 of the electrophoretic display panel 11-1R. An electrophoretic disperse liquid 60 (see FIG. 5) is sealed within each microcapsule 53.

The dot electrodes 51 of the electrophoretic display panels 11-F and 11-R are formed on a central, flexible substrate 54. The transparent electrodes (common electrodes) are transparent electrodes formed by, for example, evaporation deposition of ITO (Indium-Tin Oxide) on a transparent glass substrate 55, and are placed in opposition to the dot electrodes 51 with microcapsules 53 positioned therebetween. The transparent electrodes 50 are formed as a single electrode spanning all the dot electrodes 51.

When housing electrophoretic display panels 11-1F, 11-1R are housed in the case 31, the glass substrate 55 and transparent electrode 50 are housed in the upper face, that is, positioned on the display window side, of the case 31 relative to the dot electrodes 51 and the microcapsules 53. As a result, the display colors presented by the microcapsules 53 are externally viewable through the glass substrate 55 and transparent electrode 50.

Driving signals of a prescribed voltage are supplied from the display driver 12D of the display unit 12 to each of the dot electrodes 51 and transparent electrodes 50 via electric wiring EL, EL1 (see FIG. 4 and FIG. 5) positioned on the flexible substrate 54. The driving signals impart an electric field to the electrophoretic disperse liquid 60 sealed in the microcapsules 53. As shown in FIG. 5, black particles 61 (filled circles in FIG. 5) and white particles 62 (unfilled circles in FIG. 5) are dispersed as electrophoretic particles within the electrophoretic disperse liquid 60 within the microcapsules 53. The black particles 61 and white particles 62 are charged with opposite polarities; in this embodiment, the black particles 61 are positively charged, and the white particles 62 are negatively charged. It should be understood that charges may be reversed.

The switch SWc (FIG. 5) in the display driver 12D is connected to the low-potential power supply (ground-side power supply) VE, and the transparent electrode 50 is at 0 V potential (ground potential). In addition, when the switch SW3 in the display driver 12D is connected to the high-potential power supply (positive potential) VH side, an electric field directed from the dot electrodes 51P to the transparent electrode 50 occurs, and as shown in FIG. 5, positively-charged black particles 61 in the microcapsules 53 move to the side of the transparent electrode 50, while negatively-charged white particles 62 are drawn to the side of the dot electrodes 51P. As a result, the microcapsules 53 present a black color, and black is displayed in the dot display area A1 for external viewing.

On the other hand, when the switch SWc in the display driver 12D is connected to the high-potential power supply (positive potential) VH side, and the transparent electrode 50 is at positive potential. Simultaneously, the dot electrodes 51E are connected by switches SW1, SW2 in the display driver 12D to the low-potential power supply (ground power supply) VE side and held at ground potential. Under these conditions, the negatively-charged white particles 62 in the microcapsules 53 are drawn to the side of the transparent electrode 50, and the positively-charged black particles 61 move to the side of the dot electrodes 51E. As a result the microcapsules 53 present a white color, so that white is displayed in the dot display areas A2 and A3.

Switching of the display is performed by operating the switches SW1 to SW3, while connecting the switch SWc alternately to the high-potential side power supply VH and low-potential side power supply VE. When no potential difference exists between the transparent electrode 50 and the dot electrodes 51, no motion of the black particles 61 and white particles 62 occurs, and so the display color in the dot display area does not change. Consequently, the previous induced state is maintained.

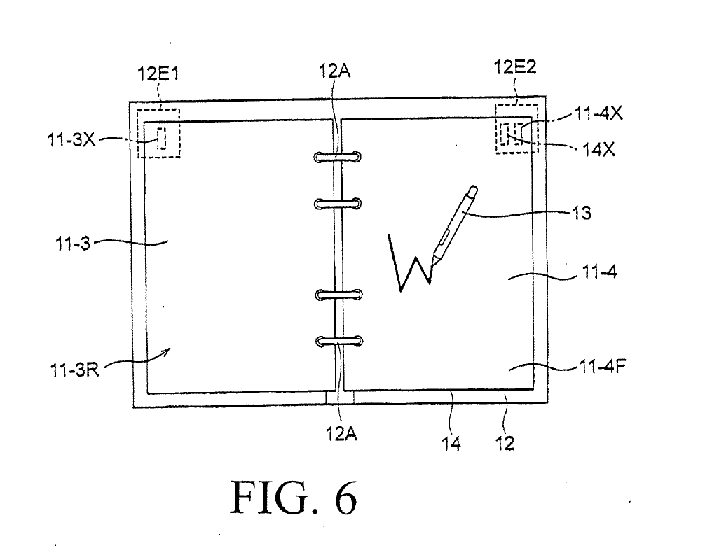

When using the notebook-type information processing device 10 in the manner illustrated in FIG. 6, the underlay-type tablet 14 is inserted to a position on the rear face of the electronic paper sheet 11-4 on which operations are to be performed. The underlay-type tablet 14 is securely installed on the ring-type holders 12A to electrically connect the underlay-type tablet 14 to the display unit 12. The position indicator 13 is then moved over the front face 11-4F, and information is input to the tablet 14.

Various methods may be employed for specifying the electronic paper 11-4 among electronic papers 11-1 to 11-6 for operations. For example, in FIG. 6 ultra-short-distance wireless communication units 12E1, 12E2, with communication distances of several centimeters, are positioned apart from one another on opposite sides of the display unit 12. IC chips 11-1x to 11-6x, to which have been written unique ID codes, are embedded in each of the electronic paper sheets 11-1 to 11-6 at positions corresponding to (e.g., disposed directly over) the ultra-short-distance wireless communication units 12E1 and 12E2.

As a result, the ID codes of the IC chips 11-1x to 11-6x are read by the ultra-short-distance wireless communication unit 12E1 and/or by the ultra-short-distance wireless communication unit 12E2, and the electronic paper sheet 11-1 to 11-6 in the uppermost position is identified. For example, in FIG. 6, the ID codes of the IC chips 11-1x to 11-3x are input to the ultra-short-distance wireless communication unit 12E1, and the ID codes of the IC chips 11-4x to 11-6x are input to the ultra-short-distance wireless communication unit 12E2, so that the electronic paper sheets in the uppermost positions are identified as the electronic paper sheet 11-3 and the electronic paper sheet 11-4.

Further, by embedding a similar IC chip 14x in the underlay-type tablet 14, and upon reading of the ID code of the IC chip 14x by the ultra-short-distance wireless communication unit 12E1 or by the ultra-short-distance wireless communication unit 12E2, it is possible to determine whether the tablet 14 has been inserted on the left or on the right side of the display unit 12. For example, in FIG. 6, it is possible to determine that the electronic paper sheet for operations is the electronic paper sheet 11-4, and that the display face below which the underlay-type tablet 14 rests is the electrophoretic display panel 11-4F.

Hence when the user inputs information with the pen-type position indicator 13 on the side of the electrophoretic display panel 11-4F in FIG. 6, the display of the electrophoretic display panel 11-4F is changed according to this input state. That is, a position specified by the user using the pen-type position indicator 13 is detected by the tablet 14 underlying the electronic paper sheet 11-4. Position information for the detected position is input to the display unit 12 based on the display position of position indicator 13 on the electronic paper 11. For example, in FIG. 6, a hand-written character (in the figure, “W”) is input based on the movement of position indicator 13 on the electronic paper sheet 11-4, and is displayed.

### [2] Second Embodiment

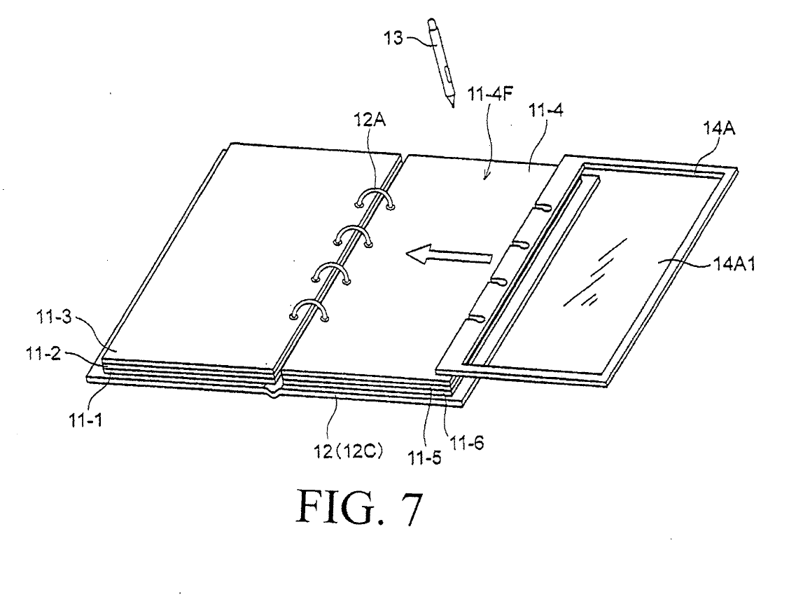

In the above first embodiment, the underlay-type tablet 14 is positioned on the rear-face side of the electronic paper sheet, e.g., 11-4, for operation. In contrast, in the second embodiment illustrated in FIG. 7, the tablet 14A is positioned on the surface side of the electronic paper sheet for operation.

The overlay-type tablet 14A of the second embodiment comprises a transparent window 14A1. When the tablet 14A is mounted in the ring-type holders 12A over the electronic paper sheets, for example in FIG. 7 on the front face 11-4F of the electronic paper sheet 11-4, the face of the electronic paper sheet, e.g., 11-4F, can be viewed through the transparent window 14A1. Further, when the user uses the pen-type position indicator 13 to perform input operations to the electrophoretic display panel 11-4F on the overlay-type tablet 14A, a corresponding display appears on the electrophoretic display panel 11-4F according to the input and display operations described above.

### [3] Third Embodiment

In the above first and second embodiments, a tablet 14, 14A is provided as a separate member, separable from display unit 12. In the third embodiments, tablets are provided for each of the left and right pages, and are provided integrally with (i.e., non-removably attached to) the display unit 12.

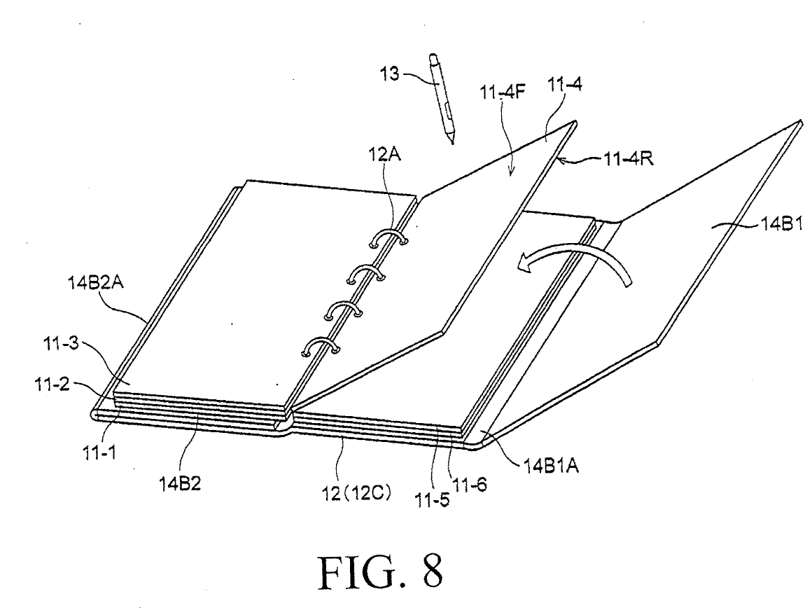

Referring now more particularly to the third embodiment illustrated in FIG. 8, shown are underlay-type tablets 14B1, 14B2 formed integrally with the display unit 12 so that tablets 14B1, 14B2 remain connected to the display unit 12 during placement of the tablets 14B1, 14B2 to their desired positions. The underlay-type tablets 14B1, 14B2 include respective hinge portions 14B1A, 14B2A which incorporate electrical wiring. As shown in FIG. 8, by rotating for example the underlay-type tablet 14B1 in the direction of the arrow, the underlay-type tablet 14B1 is positioned and inserted at the rear fade of any of the electronic paper sheets, such as sheet 11-4, on which operations are to be performed. As a result, when the user performs input operations on the side of the electrophoretic display panel 11-4F on the electronic paper sheet 11-4 using the pen-type position indicator 13, a corresponding display appears on the electrophoretic display panel 11-4F.

It should be understood that the display unit 12 may contain only a single integral tablet, or a combination of integral and non-integral tablets.

### [4] Fourth Embodiment

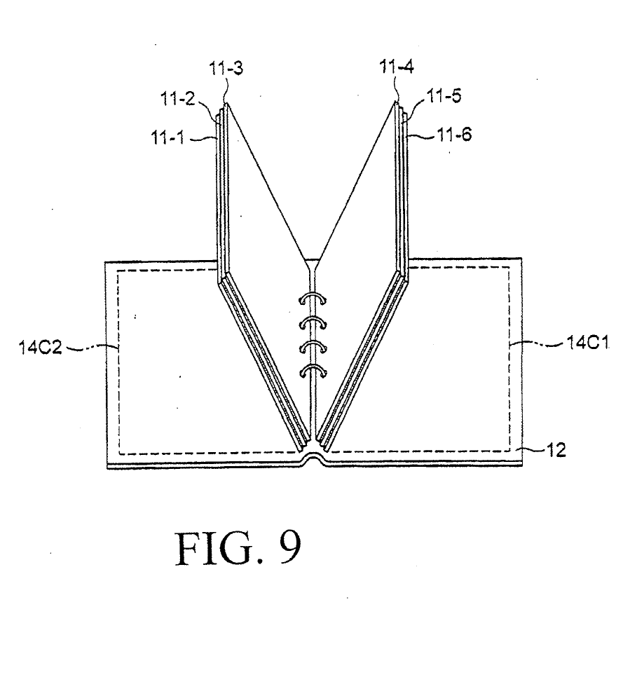

A fourth embodiment of the invention is illustrated in FIG. 9, and includes underlay-type tablets 14C1, 14C2 combined with and integrated into the notebook panels of the display unit.

When the user uses the pen-type position indicator 13 on the electronic paper sheets to make input to one of the electrophoretic display panels, the corresponding display appears on the electrophoretic display panel.

It should be understood that the display unit 12 may contain only a single tablet integrated into one of its panels, or may contain a combination of integrated and non-integrated tablets.

### [5] Fifth Embodiment

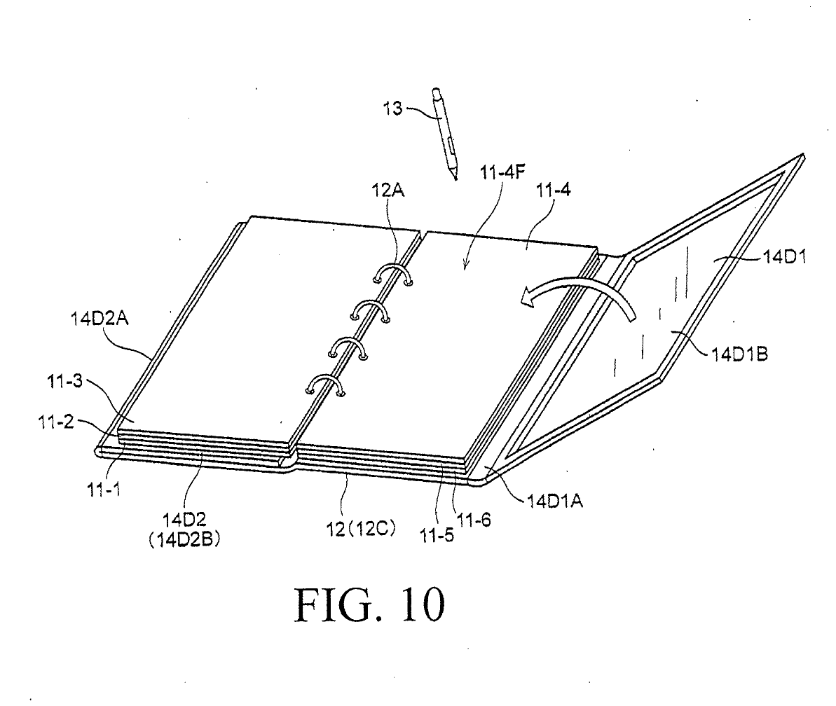

In the above-described third embodiment of FIG. 8, the integrally connected underlay-type tablet is positioned on the rear-face side of the electronic paper sheet. In contrast, according to a fifth embodiment of the invention shown in FIG. 10, an overlay-type tablet is integrally connected to the display unit 12 and further is positioned on the surface side of the electronic paper sheet for operations.

The tablets 14D1, 14D2 of this fifth embodiment comprise transparent windows 14D1B, 14D2B similar to transparent window 14A1 depicted in FIG. 7. Unlike FIG. 7, however, the tablets 14D1, 14D2 of FIG. 10 are formed integrally with the display unit 12 via hinge portions 14D1A, 14D2A, respectively. The hinge portions 14D1A, 14D2A each incorporate electrical wiring. As shown in FIG. 10, by rotating the tablet 14D1 in the direction of the arrow, the tablet 14D1 is positioned and placed upon the front surface 11-4F of the electronic paper sheet 11-4 on which operations are to be performed; this movement occurs while the tablet 14D1 remains attached to the display unit 12.

As a result, the electronic paper sheet, which in the example of FIG. 10 is the electronic paper sheet 11-4, can be viewed, and when the user uses the pen-type position indicator 13 on the tablet 14D1 to perform input operations on the side of the electrophoretic display panel 11-4F, the corresponding display appears on the electrophoretic display panel 11-4F according to the input state.

Although not shown, the tablet 14D2 may be similarly rotated about its hinge 14D2A and positioned upon the rear surface of the electronic paper sheet 11-3.

In this embodiment, the tablets 14D1, 14D2 may include additional elements or features (similar to those depicted in FIG. 1) for joining the tablets 14D1, 14D2 to the ring holders 12A. By joining the tablets 14D1, 14D2 to the ring holders 12A, unintended shifts in position of the tablets 14D1, 14D2 can easily be eliminated, and accurate input can be performed.

### [6] Sixth Embodiment

In the above first embodiment, IC chips are used to specify the electronic paper sheet for operations. In contrast, in this sixth embodiment, a tab is provided for each electronic paper sheet, and the presence or absence of tabs is optically detected to specify the electronic paper sheet selected by the user for operations.

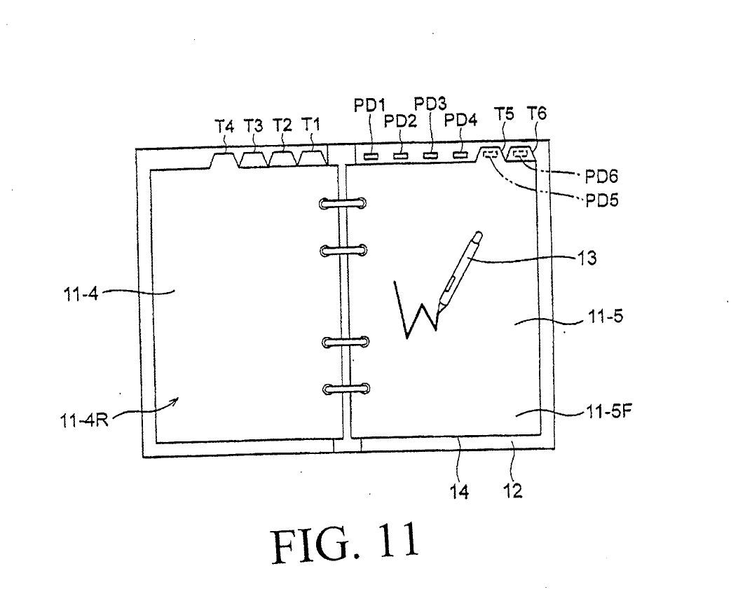

In the sixth embodiment shown in FIG. 11, tabs T1 to T6 protrude from the top ends (as oriented in FIG. 11) from the electronic paper sheets 11-1 to 11-6. The display unit 12 includes reflection-type optical sensors PD1 to PD6 provided at positions corresponding to the respective tabs T1 to T6.

The selected (uppermost) electronic paper sheet positioned on the display unit 12 is identified based on whether detection light emitted from each of the reflection-type optical sensors PD1 to PD6 is reflected by the tabs T1 to T6. In the example of FIG. 11, the detection light from the reflection-type optical sensors PD1 to PD4 is not returned to the reflection-type optical sensors PD1 to PD4, while the detection light from the reflection-type optical sensors PD5 and PD6 is returned to the reflection-type optical sensors PD5 and PD6. Hence, the electronic paper sheets in the uppermost position can be ascertained to be the electronic paper sheet 11-4 and the electronic paper sheet 11-5.

Similarly, by providing a tab or multiple tabs on the tablet 14 also, it is possible to determine whether the tablet is inserted on the left or on the right side. In the example of FIG. 11, the electronic paper sheet for operations can be identified as the electronic paper sheet 11-5, and the surface can be identified as the electrophoretic display panel 11-5F.

When the user uses the pen-type position indicator 13 to perform input on the side of the electrophoretic display panel 11-5F, the corresponding display appears on the electrophoretic display panel 11-5F according to the input and display operations described above.

### [7] Seventh Embodiment

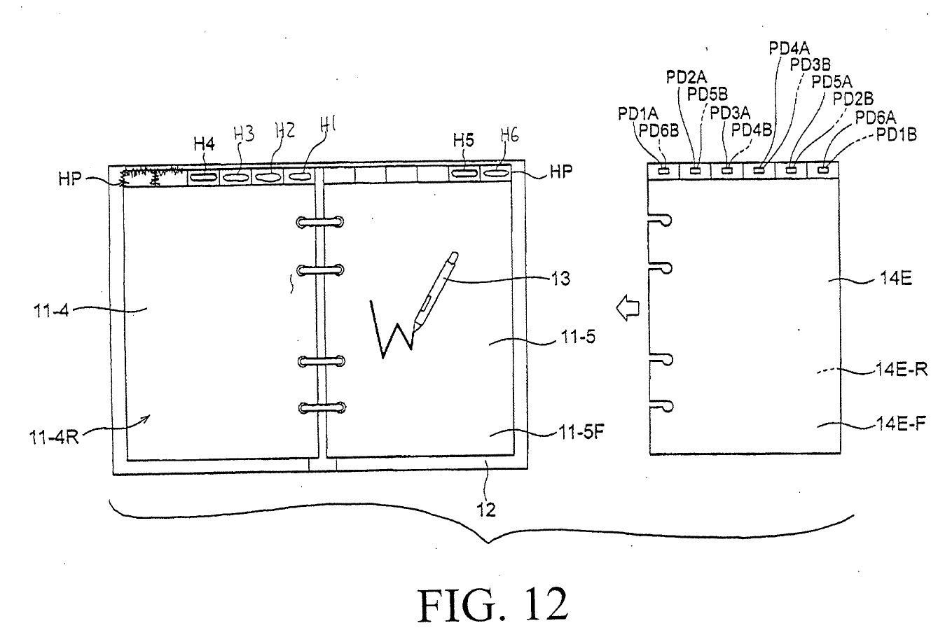

In the above first embodiment, IC chips are used to identify the electronic paper sheet selected by the user for operations. In this seventh embodiment illustrated in FIG. 12, detection holes are provided in each electronic paper sheet, and by optically detecting the positions of the detection holes, the electronic paper sheet for selected by the user for operations can be identified by the display unit 12.

In this seventh embodiment, detection hole formation portions (or tabs) HP are provided protruding above the top ends (as oriented in FIG. 12) of each of the electronic paper sheets 11-1 to 11-6, and detection holes H1 to H6 are provided in the detection hole formation portions HP of the electronic paper sheets 11-1 to 11-6, respectively. Further, reflection-type optical sensors PD1A to PD6A are provided on the surface side 14E-F of the underlay-type tablet 14E of this aspect, in positions corresponding to the detection holes H1 to H6, respectively. Reflection-type optical sensors PD1B to PD6B are provided on the rear-face side 14E-R of the underlay-type tablet 14E, in positions corresponding to the detection holes H1 to H6, respectively.

In resulting operation, the selected electronic paper sheet (e.g., 11-5 in FIG. 12) can be identified based on whether detection light, emitted from either each of the reflection-type optical sensors PD1A to PD6A or from each of the reflection-type optical sensors PD1B to PD6B, passes through the detection holes H1 to H6. For example, in the example of FIG. 12, the tablet 14E is inserted from the right side, so that detection light from the reflection-type optical sensor PD5A passes through the detection hole H5, and does not return to the reflection-type optical sensor PD5A, so that the electronic paper sheet for operations can be identified as the electronic paper sheet 11-5, and the surface can be identified as the electrophoretic display panel 11-5F.

Hence when the user uses the pen-type position indicator 13 to perform input on the side of the electrophoretic display panel 11-5F, the corresponding display appears on the electrophoretic display panel 11-5F.

### [8] Advantageous Results

As explained above, in each of the embodiments illustrated in the accompanying figures, a notebook-type information processing device including a plurality of electronic paper sheets can be used in a manner similar to that of a paper notebook, so that the user can easily write information, and can easily reference information which the user has input, e.g., written.

### [9] Modified Examples of Embodiments

Many modifications and variations to the above-described embodiments fall within the scope of the invention, including but not necessarily limited to the following.

In the above embodiments, double-faced electronic paper sheets were used; however, single-faced sheets can be used for one, multiple, or all of the electronic display sheets.

In the above embodiments, handwritten characters were input. However, it should be understood that operation buttons or similar icons may be displayed, and processing corresponding to user selection operations (e.g., file-open operation processing, processing corresponding to various instructions, and similar) may be performed.

In the above embodiments, the electronic paper sheets and the tablets are fastened using ring-type holders. The ring holders are illustrated as having a round profile. Other shapes, such as a slanted profile and spiral configuration may be used. Further, binders other than rings may be employed for retaining the electronic display sheets in the notebook form. The binders may permanently hold the electronic display sheets, or allow for removal and reinsertion of the display sheets.

The ring-type binders also are constructed for enabling electrical conduction. Alternative electrical connection schemes may be used. For example, a plurality of dedicated connectors may be provided on the display unit side, configured such that electrical connections to the connectors are made. As another alternative, the electronic paper sheets, underlay-type tablet, and display unit may be interconnected by wireless communication. It is also possible to employ electrical connections and wireless communication in combination.

In the above embodiments, electrophoretic-type members are used as the electronic paper sheets. However, it should be understood that the principles of the present invention are applicable to other types of electronic display sheets, including liquid crystal display devices, particle-movement-type devices, electrode-position methods, electro-wetting methods, flexible organic EL devices, and other devices.

In the above embodiments, the loop coils 322, 324 are described, and shown in FIG. 3, as two-turn loop coils; however, the number of turns is not limited in particular. Further, the number of loop coils 322, 324 present in the position detection portion 300 is also arbitrary, and may be dictated by the size of the position detection portion 300 and other factors.

In the above embodiments, the input face of the underlay-type tablet may be placed in direct opposing relationship with respect to the display face of an electronic paper sheet, i.e., without any interposed or buffer member between the tablet and the selected electronic paper sheet. It is possible to insert a buffer member between the tablet and the electronic paper sheet, thereby establishing an indirect opposing relationship between the tablet and the electronic display sheet. The buffer member may be used, for example, in order to modify the writing style. In the case of a transparent tablet placed in overlying relationship with the display face, a sheet (e.g., template) on which is drawn a graphic for tracing or similar practices may be inserted between the tablet and the electronic paper sheet.

In the above embodiments, a transparent electrode (common electrode) 50 and dot electrodes (matrix electrodes) are provided in an electronic paper sheet. If dot electrodes are provided in the underlay-type tablet, the manufacturing cost of each electronic paper sheet can be reduced. Another way to reduce manufacturing costs is to enclose the electronic paper sheets between underlay-type tablets, provide the transparent electrodes (common electrodes) and the dot electrodes (matrix electrodes) in the underlay-type tablets, and configure the electronic paper sheets with a flexible substrate not provided with dot electrodes in place of the glass substrate 55. Also, in the cases of these configurations there is no need for rigorous alignment of the electronic paper sheets with the underlay-type tablet, and convenience of use is improved.

In the above embodiments, configurations were explained in which positions are determined by transmission and reception of wireless signals between the pen-type position indicator 13 and the position detection portion 300. Other configurations may be practiced. For example, the pen-type position indicator 13 may incorporate a power supply device, and signals may be transmitted in one direction from the pen-type position indicator 13 to the position detection portion 300. Further, the position detection portion 300 may be configured as a pressure-sensitive tablet instead of an electromagnetic induction-type tablet. In the case of a pressure-sensitive tablet, there is no need to incorporate a coil or similar structure in the pen-type position indicator 13.

The above embodiments discuss a notebook-type information processing device. However, this invention is not limited to such a configuration. For example, application of the present invention to an input device connected to a desktop computer, a PDA (Personal Digital Assistant), an electronic dictionary, equipment having the functions of a telephone, or other portable equipment, is also possible.

It should be understood by those skilled in the art that various additional modifications, combinations, sub-combinations and alterations may occur depending on design requirements and other factors, and are within the scope of the appended claims or the equivalents thereof.

What is claimed is:

1. A portable information processing system, comprising:
a display unit comprising an electronic display and a display unit interface;
an electronic tablet detachably and reattachably mountable on the display unit, the electronic tablet comprising a transparent window positioned in overlaying arrangement on the electronic display when the electronic tablet is mounted on the display unit to permit viewing of the electronic display through the transparent window, an input processing system adapted to receive signals and process character information and coordinate information based on the signals, and an electronic tablet interface for communicating with the display unit interface of the display unit; and
a hand-holdable, hand-guidable electronic position indicator for transmitting the signals for receipt by the electronic tablet, the signals corresponding to the character and coordinate information input by hand-guided input movements of the electronic position indicator on the transparent window of the electronic tablet,
wherein communication between the electronic tablet interface and the display unit interface permits transmission of the character information and coordinate information from the electronic tablet to the display unit for displaying the character information on the electronic display at a position corresponding to the coordinate information so that the character information is displayed on the electronic display and viewable through the transparent window to a user of the portable information processing system.

2. The portable information processing system of claim 1, wherein display unit interface and electronic tablet interface permit wireless transmission of the character information and coordinate information from the electronic tablet to the display unit.

3. The portable information processing system of claim 1, wherein the display unit interface and electronic tablet interface permit wired transmission of the character information and coordinate information from the electronic tablet to the display unit.

4. The portable information processing system of claim 1, wherein the display unit comprises portable equipment.

5. The portable information processing system of claim 1, wherein the electronic tablet is configured as a pressure-sensitive tablet.

6. The portable information processing system of claim 1, wherein the electronic tablet is configured as an electromagnetic induction tablet.

7. The portable information processing system of claim 1, wherein the electronic position indicator is configured as a pen.

8. The portable information processing system of claim 1, wherein the position indicator comprises at least one coil, wherein said electronic tablet comprises a plurality of loop coils, and wherein signals are transmitted from said coil of the position indicator to the loop coils which receive the signals

9. The portable information processing system of claim 1, wherein the position indicator comprises at least one coil, and wherein the electronic tablet is configured as an electromagnetic induction tablet and comprises a plurality of loop coils which receive the signals transmitted from the coil of the position indicator.

10. The portable information processing system of claim 9, wherein the loop coils are arranged in an x-y grid.

11. A tablet system connectable to a display unit including an electronic display and a display unit interface, the tablet system comprising:
an electronic tablet detachably and reattachably mountable on the display unit, the electronic tablet comprising a transparent window positioned in overlaying arrangement on the electronic display when the electronic tablet is mounted on the display unit to permit viewing of the electronic display through the transparent window, an input processing system adapted to receive signals and process character information and coordinate information based on the signals, and an electronic tablet interface for communicating with the display unit interface of the display unit; and
a hand-holdable, hand-guidable electronic position indicator for transmitting the signals for receipt by the electronic tablet, the signals corresponding to the character and coordinate information input by hand-guided input movements of the electronic position indicator on the transparent window of the electronic tablet,
wherein communication between the electronic tablet interface and the display unit interface permits transmission of the character information and coordinate information from the electronic tablet to the display unit for displaying the character information on the electronic display at a position corresponding to the coordinate information so that the character information is displayed on the electronic display and viewable through the transparent window to a user of the portable information processing system.

12. The tablet system of claim 11, wherein display unit interface and electronic tablet interface permit wireless transmission of the character information and coordinate information from the electronic tablet to the display unit.

13. The tablet system of claim 11, wherein the display unit interface and electronic tablet interface permit wired transmission of the character information and coordinate information from the electronic tablet to the display unit.

14. The tablet system of claim 11, wherein the display unit comprises portable equipment.

15. The tablet system of claim 11, wherein the electronic tablet is configured as a pressure-sensitive tablet.

16. The tablet system of claim 11, wherein the electronic tablet is configured as an electromagnetic induction tablet.

17. The tablet system of claim 11, wherein the electronic position indicator is configured as a pen.

18. The portable information processing system of claim 11, wherein the position indicator comprises at least one coil, wherein said electronic tablet comprises a plurality of loop coils, and wherein signals are transmitted from said coil of the position indicator to the loop coils which receive the signals

19. The portable information processing system of claim 11, wherein the position indicator comprises at least one coil, and wherein the electronic tablet is configured as an electromagnetic induction tablet and comprises a plurality of loop coils which receive the signals transmitted from the coil of the position indicator.

20. The portable information processing system of claim 19, wherein the loop coils are arranged in an x-y grid.
